(19) United States
(12) Patent Application Publication
(10) Pub. No.: US 2012/0108316 A1
(43) Pub. Date: May 3, 2012

(54) GAMING SYSTEM AND A METHOD OF GAMING

(75) Inventor: George Roukis, Miranda (AU)

(73) Assignee: ARISTOCRAT TECHNOLOGIES AUSTRALIA PTY LIMITED, North Ryde (AU)

(21) Appl. No.: 13/315,864

(22) Filed: Dec. 9, 2011

Related U.S. Application Data
(63) Continuation of application No. 12/241,838, filed on Sep. 30, 2008, now abandoned.

(30) Foreign Application Priority Data
Oct. 1, 2007 (AU) 2007905347

(51) Int. Cl. A63F 13/00

(52) U.S. Cl. 463/20

(57) ABSTRACT

A gaming method, game controller, gaming system, and computer program code are disclosed where play can be conducted in a game having a plurality of symbols for use during play. Game win outcomes are determined by one or more symbols occurring according to game play rules. When a particular game play event occurs involving one or more of the symbols, an adjusted pay scale is provided. In an example the particular event is when one or more symbols occur at a particular location in an image depicting game play. In an example, the one or more symbols for the events are different to the one or more symbols for game win outcomes.

### CROSS-REFERENCE TO RELATED APPLICATIONS

This patent arises from a continuation of U.S. patent application Ser. No. 12/241,838, filed Sep. 30, 2008, entitled “A GAMING SYSTEM AND A METHOD OF GAMING,” which claims the benefit of priority to Australian Provisional Patent Application No. 2007905347, filed on Oct. 1, 2007, entitled “A GAMING SYSTEM AND A METHOD OF GAMING”, which is herein incorporated by reference in its entirety.

### FIELD

The present invention relates to a gaming system, a method of gaming, a game controller and computer program code.

### BACKGROUND TO THE INVENTION

It is known to provide a gaming system which comprises a game controller arranged to randomly display several symbols from a predetermined set of symbols and to determine a game outcome such as a game win based on the displayed symbols. Such gaming systems may commonly be implemented as a stepper machine provided with reels with each reel carrying several symbols of the set, or a video machine wherein selected symbols are displayed on virtual reels on a video display.

While such gaming systems provide users with enjoyment, a need exists for alternative gaming systems in order to maintain or increase player enjoyment.

### SUMMARY OF THE INVENTION

In a first aspect, the invention provides method of gaming including:
conducting play in a game having a plurality of symbols for use during play and from which game win outcomes can be determined, and
when a designated event involving one or more symbols occurs in the game, providing an adjusted pay scale for at least one game win outcome involving one or more symbols.

In an embodiment, the designated event is when game is a game having multiple columns and wherein the designated event is when one or more symbols occur in the game at a particular location in one or more columns.

In an embodiment, the designated event is when the game win outcome is when the one or more symbols of a game win outcome are different to the designated event symbol.

In a second aspect, the invention provides game controller for a gaming system, the game controller is arranged to:
conduct game play with a plurality of symbols, and to enable a game win outcome to be determined from the plurality of symbols,
and on the occurrence of a designated event involving one or more symbols in the game, to adjust a pay scale for at least one game win outcome involving one or more symbols.

In an embodiment, the game controller is arranged to:
play a game with multiple columns and to,
enable the designated event to occur when one or more symbols occur in the game at a particular location in one or more columns.

In an embodiment, the game controller is arranged to provide a game win outcome when one or more symbols in the game win outcome are different symbols to the one or more symbols that occur in the designated event.

In a third aspect, the invention provides a gaming system including:
a display to enable a player to view game play and designated events and game win outcomes,
and a game controller as described above.

In a fourth aspect, the invention provides computer program code which when executed by a processor in a computer implements the above method.

In a fifth aspect the invention provides a computer readable medium including the program code.

### BRIEF DESCRIPTION OF THE DRAWINGS

Certain embodiments of the invention will now be described in relation to the following drawings in which:

FIG. 1 is a block diagram of the core components of a gaming system;

FIG. 2 is a perspective view of a gaming machine;

FIG. 3 is a block diagram of the functional components of a gaming machine;

FIG. 4 is a block diagram representing the structure of a memory;

FIG. 5 is a diagram schematic of a networked gaming system;

FIG. 6 is a further block diagram of the gaming system; and

FIG. 7 is a flowchart of a preferred embodiment.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EMBODIMENTS

An embodiment provides a gaming system where a player plays at least one game, and preferably a sequence of games. Here the game has a plurality of symbols for use during game play and from which game win outcomes can be determined When a designated event occurs in the game involving one or more symbols, an adjusted pay scale is provided for a game win outcome involving one or more symbols. This game win outcome can be provided in a current game round or in a subsequent game round. The game can be a feature game triggered from a base game.

The gaming system may be provided in a number of different forms.

In a first form, a stand alone gaming machine is provided wherein all or most components for implementing the game are present in a player operable gaming machine.

In a second form, a distributed architecture is provided wherein some of the components for implementing the game are present in a player operable gaming machine and some of the components for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

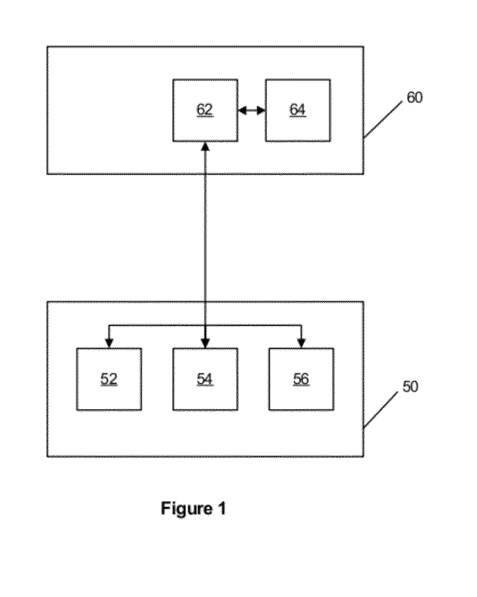

Irrespective of the form, the gaming system includes several core components. At the broadest level, the core components are a player interface 50 and a game controller 60 as illustrated in FIG. 1. The player interface is arranged to enable manual interaction between a player and the gaming system and for this purpose includes the input/output components for the player to enter instructions and play the game.

Components of the player interface may vary from embodiment to embodiment but will typically include a credit mechanism 52 to enable a player to input credits and receive payouts, one or more displays 54 and a game play mechanism 56 that enables a player to input game play instructions and a sound reproducing device (not specially shown).

The game controller 60 is in data communication with the player interface and typically includes a processor 62 that processes the game play instructions in accordance with game play rules and outputs game play outcomes to the display. Typically, the game play instructions are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server.

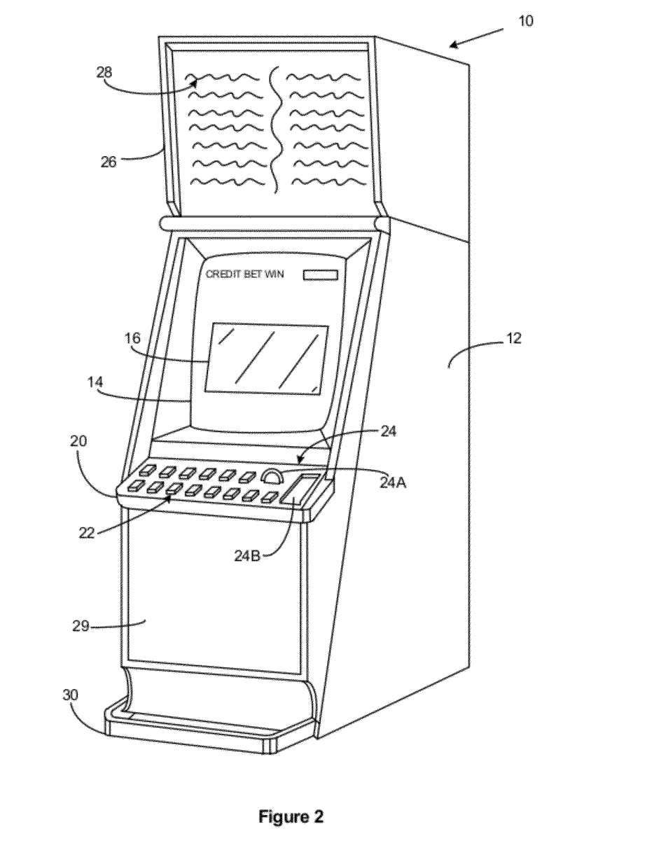

A gaming system in the form of a stand alone gaming machine 10 is illustrated in FIG. 2. The gaming machine 10 includes a console 12 having a display 14 on which is displayed representations of a game 16 that can be played by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. A player marketing module has a reading device may also be provided for the purpose of reading a player tracking device, for example as part of a loyalty program. The player tracking device may be in the form of a card, flash drive or any other portable storage medium capable of being read by the reading device.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or of a different type.

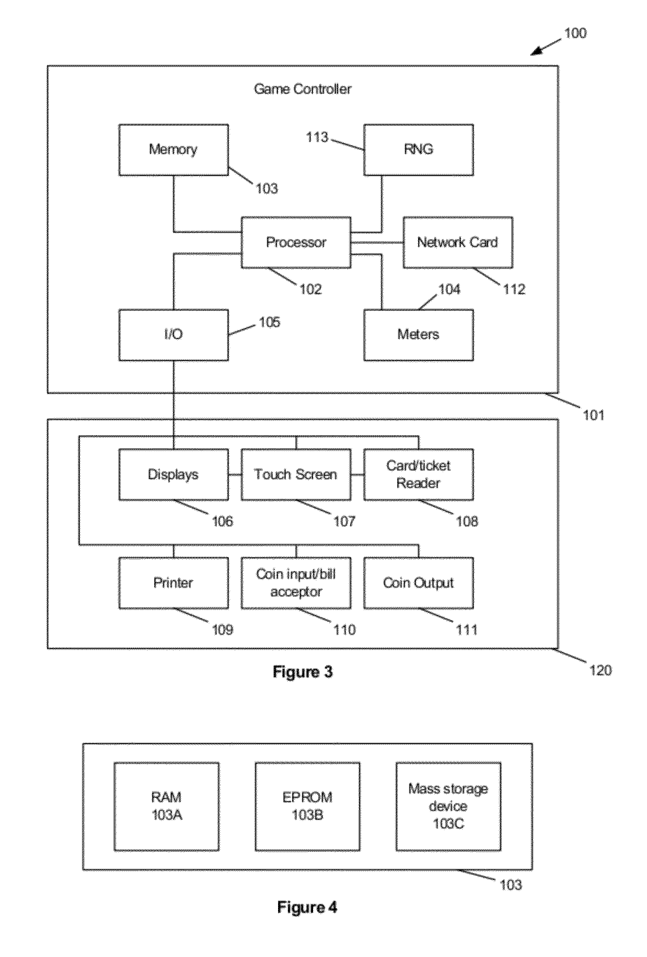

FIG. 3 shows a block diagram of operative components of a typical gaming machine which may be the same as or different to the gaming machine of FIG. 2.

The gaming machine 100 includes a game controller 101 having a processor 102. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 include one or more displays 106, a touch screen 107 (or buttons for user interface), a card and/or ticket reader 108, a printer 109, a bill acceptor and/or coin input mechanism 110 and a coin output mechanism 111. Additional hardware may be included as part of the gaming machine 100, or hardware may be omitted based on the specific implementation.

In addition, the gaming machine 100 may include a communications interface, for example a network card 112. The network card may, for example, send status information, accounting information or other information to a central controller, server or database and receive data or commands from the central controller, server or database.

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, for example input/output devices 106,107,108,109,110,111 to be provided remotely from the game controller 101.

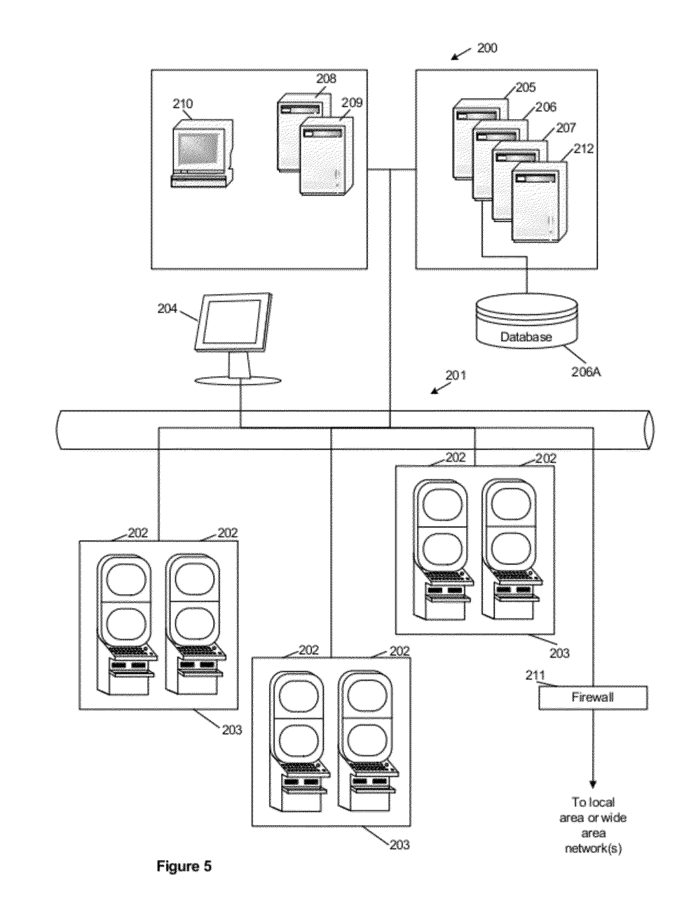

FIG. 5 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10,100 shown in FIGS. 2 and 3, or may have simplified functionality depending on the requirements for implementing game play. While banks 203 of two gaming machines are illustrated in FIG. 5, banks of one, three or more gaming machines are also envisaged.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to carry out the accounting in respect of the Jackpot game. A loyalty program server 212 may also be provided.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming network 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of games servers could be provided to run different games or a single game server may run a plurality of different games depending upon the terminals.

The embodiment may be implemented in relation to a spinning reel type game. Gaming systems for implementing games that involve a display of spinning reels as part of the display of the outcome of a game have either a video display or a mechanical display, these later machines most usually being “stepper” machines which have a separate motor for each reel. However, persons skilled in the art will appreciate that the invention can be implemented in respect if other forms of games, including; card games; ball draw games (e.g. bingo or keno); dice games; and pin and ball games, and that spinning reels can be replaced with columns with changing symbols.

In some implementations the game controllers of such gaming machines select symbols by employing a stop determining function that randomly determines the stop position for each reel. For example, if there are five reels, each having twenty symbols, the stop determining function might determine that the stop positions are positions: 3, 13, 7, 9 and 17. The spinning of the reels is then controlled so that each symbol comes to a stop in the same row, typically a predetermined row in a “window” visible to the player on the display that which corresponds to a player playing a single win line. When a reel stops, the symbols will be in one of a plurality of possible symbol positions for that reel relative to the stop position.

Spinning reel type games typically allow a player to select how many win lines of a plurality of win lines they will play in each game—i.e. a minimum of one win line up to the maximum number of win lines allowed by the game. Persons, skilled in the art, will appreciate that in other embodiments, the player may select a number of reels to play. Each win line is formed by a set of symbol positions consisting of one symbol position from each reel. That is, a predetermined symbol position of each reel is assigned to a win line. The symbol positions that constitute each of the win lines are usually advertised to the player by markings on the display or diagrams showing the symbol positions that correspond to each win line. Some of the win lines will be horizontal or diagonal lines. Typically, the win lines will be constituted by symbol positions in the visible window. A game outcome is determined based on the symbols on the win lines and a prize table that specifies awards.

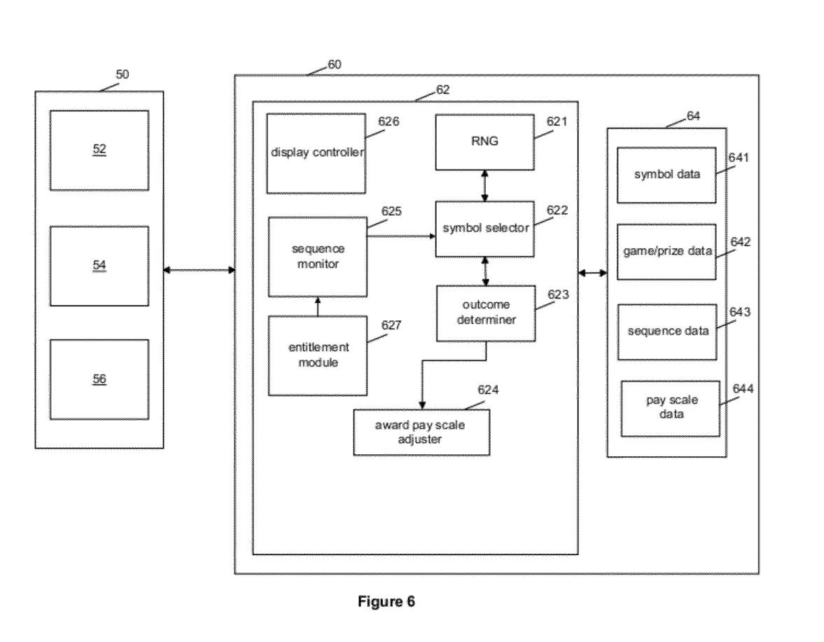

The game controller 60 of the embodiment is shown in more detail in FIG. 6. It will apparent that the processor 62 implements a number of modules, namely random number generator module 621, symbol selector module 622, outcome determiner module 623, award determiner module 624, sequence monitoring module 625, entitlement module 627 and display controller module 626 based on data stored in memory 64. Persons skilled in the art will appreciate that not all modules need be implemented by processor 62. For example, the random number generator module 621 could be implemented by a separate circuit or by a random number generator server.

In the embodiment, the entitlement module 627 determines when a player is entitled to play the game from a base game. There may be one or more plays in the game. For example, a triggering event such as a particular symbol occurring in a base game can trigger play in the game. Other triggers can be used, as would be apparent to those skilled in the art.

When the entitlement is established, the entitlement module 627 instructs the sequence monitor 625 to initiate a feature game having a sequence of one or more games based on a number of games specified in sequence data 643. The sequence monitor 625 is arranged to keep track of the sequence to ensure that all games of the sequence are carried out accordingly after each game in the sequence, the sequence monitor 625 updates the sequence data 643 to indicate how many games remain in the sequence.

During each game of a sequence, the symbol selector 622 selects the symbols to appear based on symbol data 641 which specifies the available symbols. The symbols are selected by the symbol selector using a random number obtained from the random number generator 621. The outcome determiner module 623 determines the game outcomes. The pay scale adjuster 624 then adjusts an amount for outcomes using pay scale data at 644. The adjustment is based on the number of win lines the player is playing and the symbol combinations. Persons skilled in the art will also appreciate that the game outcomes and their associated prizes are displayed on the display 54 under control of the display controller 626.

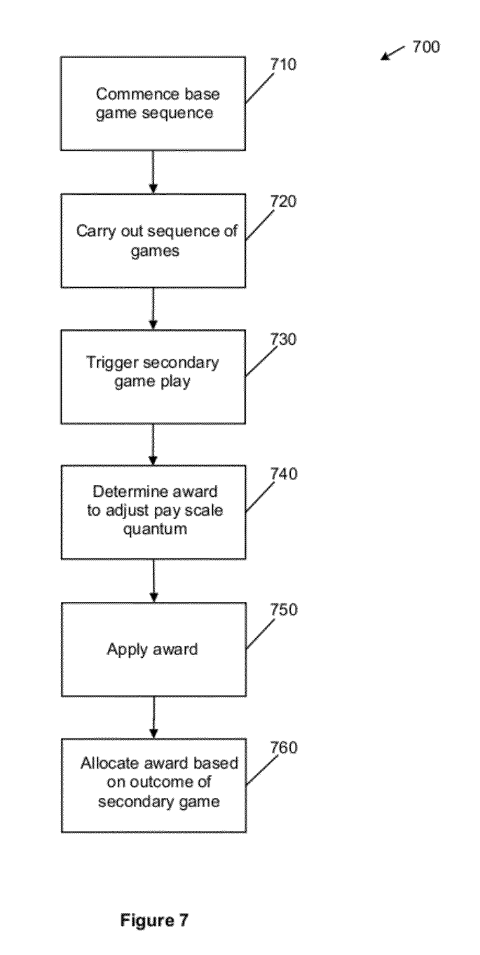

The method 700 of an embodiment of the invention is summarised in FIG. 7. At step 710 it is determined that a base game sequence should commence. The game controller 60 then carries out a sequence of base games 720, determines the award if the base game has an award, triggers the particular game play 730, which could be identified as a secondary game or a feature game, determines the award 740 and adjusts an award pay-scale quantum if a designated event occurs in the feature game, applies the award 750 and awards the player 760 based on the outcome of the game.

### Example

A player is playing a base game and an event therein triggers a feature game play. When a designated event occurs in the feature game, this triggers the pay scale for a game outcome to change such as by an arbitrary/random amount. The game outcome may be dependent on the occurrence of one or more symbols or a unique combination of symbols. In one example, played with multiple spinning reels the game outcome may be when a WILD symbol appears on one or more reels. Persons skilled in the art will appreciate that multiple spinning reels may be replaced by multiple columns of changing symbols, and that multiple spinning reels is merely one frequently used option for game play and multiple columns is to be understood to be a term to encompass multiple spinning reels.

In the particular example of the embodiment free feature games are triggered from a base game. Such triggering can be by any known way of triggering further games. A series of free games then begins to play. Each time a SCATTER appears on reel three of a five reel game this triggers a designated event, and the scorecard of a WILD symbol if it should occur on one or more other reels will increase the pay out quantum by a random/arbitrary amount. Thus, the occurrence of a SCATTER symbol in a game on reel three, triggers a designated event, and if the WILD symbol then appears on one or more reels as an outcome the pay scale is adjusted. Persons skilled in the art will appreciate that the designated event could occur in any reel, and reel three is just one example. Further two or more of the same or different symbols can be used for the designated event.

For example when the designated event occurs, a symbol such as a WILD symbol appearing on respective reels in an award outcome can provide a game win outcome award as set out below.

On a designated event occurring, the WILD scorecard for a game win outcome will increase (be adjusted by a random/arbitrary amount) as follows:

| | | |
|---|---|---|
| number of occurrences | 5 | 1000 |
| number of occurrences | 4 | 500 |
| number of occurrences | 3 | 100 |
| number of occurrences | 2 | 5 |

At, for example, free game number three if a SCATTER should appear on reel three, then this causes the scorecard of the symbol such as the WILD symbol to increase (be adjusted by a random/arbitrary amount) as follows:

| | | |
|---|---|---|
| number of occurrences | 5 | 1500 |
| number of occurrences | 4 | 700 |
| number of occurrences | 3 | 200 |
| number of occurrences | 2 | 20 |

At, for example, free game number five, if a SCATTER symbol again appears on reel three, this causes the scorecard of the WILD symbol to increase (be adjusted by a further arbitrary/random amount) as follows:

| | | |
|---|---|---|
| number of occurrences | 5 | 2000 |
| number of occurrences | 4 | 900 |
| number of occurrences | 3 | 500 |
| number of occurrences | 2 | 35 |

And so on.

On the occurrence of another unique symbol designated event, the scorecard of a symbol in an outcome, such as the WILD symbol, can be used to reset the pay scale back to a normal pay scale or to a prior pay scale. This could be, for example, if a SCATTER symbol appears on reel 1. Alternatively, if a SCATTER symbol simultaneously appears on reels 1 and 3, then the scorecard of any symbol, such a WILD symbol or a SCATTER symbol can be further adjusted. In one such case, they may each cancel each other out, or it may be that no change is applied.

Thus, it can be seen that the designated event can involve one or more symbols, and that these could be the same symbols or different symbols. Further, the game win outcome can be with the same symbols as the symbols that result in the designated event, or it may be with different symbols, or combinations thereof.

Those skilled in the art will appreciate that the game may be played with a single win line or with multiple win lines.

It is to be understood that, if any prior art publication is referred to herein, such reference does not constitute an admission that the publication forms a part of the common general knowledge in the art, in Australia or any other country.

In the claims which follow and in the preceding description of the invention, except where the context indicates otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Several embodiments are described above with reference to the drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any electronic device and/or machine-readable media suitable for accomplishing its operations. Certain embodiments of the present invention may be implemented using an existing computer processor and/or by a special purpose computer processor incorporated for this or another purpose or by a hardwired system, for example.

Embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Method steps associated with certain embodiments may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represents examples of corresponding acts for implementing the functions described in such steps.

1. A method of gaming comprising:
conducting play in a game having a plurality of symbols for use during play and from which game win outcomes can be determined, and
when a designated event involving one or more symbols occurs in the game, providing an adjusted pay scale for at least one game win outcome involving one or more symbols.

2. A method as claimed in claim 1, wherein the game has multiple columns and wherein the designated event is when one or more symbols occur in the game at a particular location in one or more columns.

3. A method as claimed in claim 1, wherein the one or more symbols of a game win outcome are different to a symbol of the designated event.

4. A method as claimed in claim 1, wherein the game win outcome is when the one or more symbols are the same symbol as each other.

5. A method as claimed in claim 1, wherein on the occurrence in a game outcome of a symbol the same as a symbol resulting in the occurrence of the designated event, causing a pay scale to be adjusted differently to any previous adjustment, or to remain unchanged.

6. A method as claimed in claim 1, comprising adjusting a quantum of the pay scale according to a random amount.

7. A method as claimed in claim 1, where the game is triggered to play from a base game.

8. A game controller for a gaming system, the game controller arranged to:
conduct game play with a plurality of symbols, and to enable a game win outcome to be determined from the plurality of symbols,
and on the occurrence of a designated event involving one or more symbols in the game, to adjust a pay scale for at least one game win outcome involving one or more symbols.

9. A game controller as claimed in claim 8 arranged to:
play a game with multiple columns and to,
enable the designated event to occur when one or more symbols occur at a particular location in one or more columns.

10. A game controller as claimed in claim 8, arranged to:
provide a game win outcome when one or more symbols in the game win outcome are different symbols to a symbol that occurs in the designated event.

11. A game controller as claimed in claim 8, arranged to enable a game win outcome when one or more symbols therein are the same symbol.

12. A game controller as claimed in claim 8, arranged to:
on the occurrence in a game win outcome with a symbol the same as a symbol occurring in the designated event,
cause a pay scale to be adjusted differently to any previous adjustment, or to remain unchanged.

13. A game controller as claimed in claim 8, arranged to:
adjust a quantum of the pay scale according to a random amount.

14. A game controller as claimed in claim 8, arranged to:
trigger game play from a base game.

15. A gaming system comprising:
a display to enable a player to view game play and designated events and game win outcomes,
and a game controller arranged to conduct game play with a plurality of symbols, and to enable a game win outcome to be determined from the plurality of symbols, and, on the occurrence of a designated event involving one or more symbols in the game, to adjust a pay scale for at least one game win outcome involving one or more symbols.

16. A game controller as claimed in claim 15 arranged to:
play a game with multiple columns and to,
enable the designated event to occur when one or more symbols occur at a particular location in one or more columns.

17. A game controller as claimed in claim 15, arranged to:
provide a game win outcome when one or more symbols in the game win outcome are different symbols to a symbol that occurs in the designated event.

18. A game controller as claimed in claim 15, arranged to enable a game win outcome when one or more symbols therein are the same symbol.

19. A game controller as claimed in claim 15, arranged to:
on the occurrence in a game win outcome with a symbol the same as a symbol occurring in the designated event,
cause a pay scale to be adjusted differently to any previous adjustment, or to remain unchanged.

20. A computer readable medium comprising computer program code which when executed by a processor in a computer implements a method of gaming comprising:
conducting play in a game having a plurality of symbols for use during play and from which game win outcomes can be determined, and
when a designated event involving one or more symbols occurs in the game, providing an adjusted pay scale for at least one game win outcome involving one or more symbols.
